(19) United States
(12) Patent Application Publication
(10) Pub. No.: US 2026/0186552 A1
(43) Pub. Date: Jul. 2, 2026

(54) POWER OPTIMIZATION, SCALING, AND TRAFFIC PREDICTION TECHNIQUES FOR AECS AND DSP SYSTEMS

(71) Applicant: MaxLinear, Inc., Carlsbad, CA (US)

(72) Inventors: Curtis Ling, Carlsbad, CA (US); Masoud Koochakzadeh, Carlsbad, CA (US); Sheng Ye, Carlsbad, CA (US); John Andrew Guckenberger, Carlsbad, CA (US); Sridhar Ramesh, Carlsbad, CA (US)

(73) Assignee: MaxLinear, Inc., Carlsbad, CA (US)

(21) Appl. No.: 19/435,411

(22) Filed: Dec. 29, 2025

Related U.S. Application Data
(60) Provisional application No. 63/739,470, filed on Dec. 27, 2024.

(51) Int. Cl. G06F 1/3234; G06F 1/3206; G06F 1/3287

(52) U.S. Cl. CPC G06F 1/3243; G06F 1/3206; G06F 1/3287

(57) ABSTRACT

A device includes a plurality of digital signal processors (DSPs) and analog crossbars in communication with the DSPs. The DSPs and crossbars dynamically adjust power consumption based on traffic load and/or a signal quality, leveraging traffic prediction models to optimize resource allocation. The system supports features such as powering down unused lanes, asymmetrically deactivating transmission or receiving lanes, and preemptively scaling resources during predicted traffic increases. Dynamic voltage and frequency scaling (DVFS) optimizes power usage based on link utilization and traffic priority, minimizing latency impacts during transitions. The switch controller integrates traffic prioritization algorithms, including weighted round-robin (WRR), to allocate power and bandwidth efficiently to high-priority traffic flows. Redundant crossbars handle overflow traffic or failover scenarios, transitioning between standby and active states dynamically.

### RELATED APPLICATION

This application claims the benefit of U.S. Provisional Application No. 63/739,470, filed Dec. 27, 2024, the disclosure of which is incorporated herein by reference in its entirety.

The examples discussed in the present disclosure are related to power optimization, scaling, and traffic prediction techniques for AECS and DSP systems.

### BACKGROUND

Unless otherwise indicated herein, the materials described herein are not prior art to the claims in the present application and are not admitted to be prior art by inclusion in this section.

Datacenters and artificial intelligence (AI) clusters may use Ethernet switches that are packet switched. Using a packet switched Ethernet switch results in delivery that is not reliable, is variable, and has high latency. Fabric switches provide another possibility in datacenters and AI clusters. Fabric switches, unlike Ethernet switches, are equivalent to circuit-switched networks, rather than packet-switched networks.

The subject matter claimed in the present disclosure is not limited to examples that solve any disadvantages or that operate only in environments such as those described above. Rather, this background is only provided to illustrate one example technology area where some examples described in the present disclosure may be practiced.

### SUMMARY

In some embodiments, a device includes digital signal processors (DSPs) and analog crossbars in communication with the DSPs, configured to dynamically adjust power consumption based on traffic load. By selectively powering down unused lanes, asymmetrically deactivating transmission or receiving lanes, and preemptively scaling resources during traffic surges, the device optimizes energy efficiency while maintaining performance.

The device further incorporates a switch controller, which manages power adjustments for DSPs and crossbars using predictive traffic models and real-time metrics. The switch controller integrates dynamic voltage and frequency scaling (DVFS) and traffic prioritization algorithms, such as weighted round-robin (WRR), to allocate resources effectively. Redundant crossbars are dynamically activated to handle overflow traffic or support failover scenarios, ensuring seamless operation and scalability in high-speed networking environments. These combined features enable the device to deliver optimized power management, resource scaling, and traffic prioritization. A method may include connecting digital signal processors to analog crossbars and adjusting power consumption based on a traffic load. Alternatively or in addition, the method may include adjusting power consumption based on a signal quality.

The objects and advantages of the examples will be realized and achieved at least by the elements, features, and combinations particularly pointed out in the claims.

Both the foregoing general description and the following detailed description are given as examples and are explanatory and are not restrictive of the invention, as claimed.

### BRIEF DESCRIPTION OF THE DRAWINGS

Examples will be described and explained with additional specificity and detail through the use of the accompanying drawings in which:

FIG. 1 illustrates an example device including digital signal processors and analog crossbars, in accordance with some embodiments;

FIG. 2 illustrates an example process flow of a device for adjusting power consumption, in accordance with some embodiments;

FIG. 3 illustrates an example communication system operable for adjusting power consumption, in accordance with some embodiments; and

FIG. 4 illustrates a diagrammatic representation of an exemplary computing device within which a set of instructions, in accordance with some embodiments.

FIG. 5A illustrates an example block diagram of a data center.

FIG. 5B illustrates an example switch device.

FIG. 5C illustrates an example switch device.

FIG. 5D illustrates an example switch device.

### DESCRIPTION

The systems and methods of the examples described below pertains to the field of high-speed network switches and so-called physical media dependent (PMD) devices with crossbar-based architectures. Modern networks often experience fluctuating traffic patterns and congestion, requiring dynamic and efficient allocation of crossbar resources. Traditional static or fixed-path routing techniques lack the flexibility to respond to real-time network demands, often leading to inefficient bandwidth utilization and increased latency.

In the embodiments described below, dynamic power management techniques are employed within an analog electrical circuit switch (AECS) to optimize energy efficiency and resource allocation across varying traffic conditions. These techniques include dynamic scaling, traffic prediction, and power optimization, enabling the system to adjust resource utilization in real time. By scaling power consumption based on traffic load, the AECS system reduces energy usage during low-demand periods while maintaining high performance during traffic surges

The embodiments described below, introduce a transformative approach to power management in AECS systems, balancing energy efficiency with high-speed performance. By integrating dynamic scaling and predictive traffic models, the system preemptively adjusts resources to handle traffic fluctuations, minimizing energy consumption without sacrificing reliability. Selectively deactivating unused lanes or components further conserves power, reducing operational costs and environmental impact.

In some embodiments, the integration of dynamic voltage and frequency scaling (DVFS) and traffic prioritization ensures that latency-sensitive traffic receives resources, even during power-saving transitions. Redundant crossbars enhance system resilience, dynamically activating to handle overflow traffic or failover scenarios. These combined features deliver a scalable, energy-efficient solution ideal for data centers, telecommunications, and other high-performance networking environments, where efficient resource management is used for operational success. Examples of the described herein will be explained with reference to the accompanying drawings.

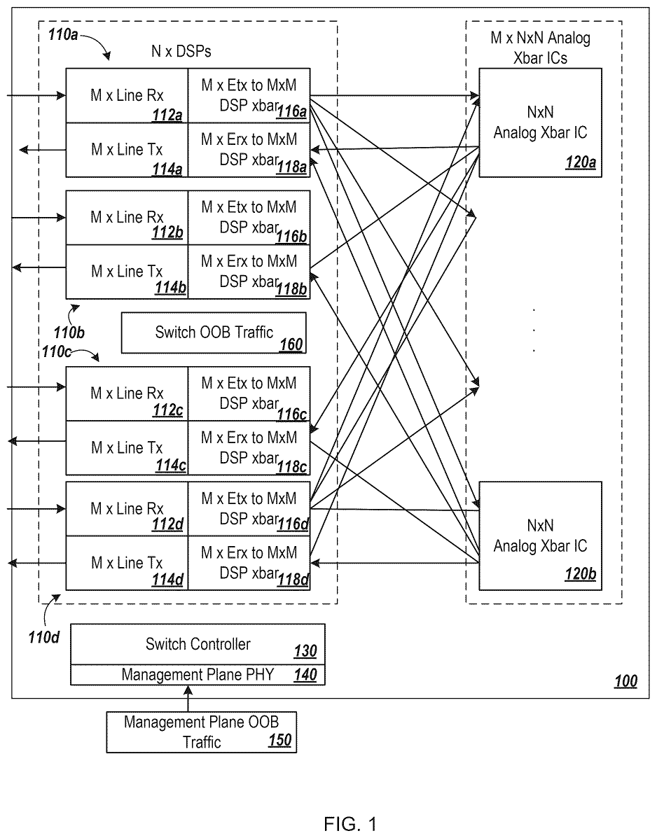

As illustrated in FIG. 1, an AECS (interchangeably “system 100”) may include one or more digital signal processors (DSPs) 110a, 110b, 110c, 110d. The AECS may include a switch controller 130. System 100 may include one or more analog crossbars (“xbar”) integrated circuits (IC) (e.g., analog crossbars 120a, 120b). The system 100 may include a management plane physical layer 140 and/or management plane OOB traffic 150, which may be directed to the management plan physical layer 140. The system 100 may have switch out-of-band (OOB) traffic 160.

The DSPs 110a, 110b, 110c, 110d may be devices integrating layer 1 (L1) for line and switch side inputs and outputs. A DSP 110a may include an M×Line Rx 112a, an M×Line Tx 114a, an M×ETx to M×M DSP xbar 116a, and an M×ERx to M×M DSP xbar 118a. A DSP 110b may include an M×Line Rx 112b, an M×Line Tx 114b, an M×ETx to M×M DSP xbar 116b, and an M×ERx to M×M DSP xbar 118b. A DSP 110c may include an M×Line Rx 112c, an M×Line Tx 114c, an M×ETx to M×M DSP xbar 116c, and an M×ERx to M×M DSP xbar 118c. A DSP 110d may include an M×Line Rx 112d, an M×Line Tx 114d, an M×ETx to M×M DSP xbar 116d, and an M×ERx to M×M DSP xbar 118d. A DSP xbar may be a digital crossbar integrated in the DSP.

A physical media-dependent (PMD) device may include a DSP 110a, 110b, 110c, 110d. The PMD may be an electrical-optical module or an electrical-electrical module.

A client may be a system communicating line-side in-band traffic to the AECS 100. For example, a server may be a system communicating line-side in-band traffic to the AECS 100.

Line-side in-band (IB) bandwidth may be line traffic communicated to or from a client. IB switch traffic may be IB traffic directed into or out of or within the AECS 100.

The switch controller (SC) 130 may manage and control AECS 100 devices. In one example, the switch controller 130 may be a microcontroller unit (MCU). Alternatively or in addition, the switch controller 130 may be a DSP.

Switch out-of-band (OOB) traffic may be traffic among the SC 130, DSP 110a, 110b, 110c, 110d, analog crossbars 120a, 120b carried on a different network and physical layer than IB; may be carried on analog crossbars 120a, 120b with redundancy.

An “Xbar IC” may be an analog Xbar IC which may be a chip implementing an analog crossbar with input and output lanes.

Management plane OOB traffic may be traffic from outside the AECS via management plane physical layer (PHY) to configure and manage the AECS.

A device (e.g., an AECS 100) may include DSPs 110a, 110b, 110c, 110d and analog crossbars 120a, 120b. The analog crossbars 120a, 120b may be in communication with the DSPs 110a, 110b, 110c, 110d. The DSPs 110a, 110b, 110c, 110d may adjust power consumption based on a traffic load. There are various techniques for dynamically adjusting power consumption based on traffic load. For example, analog crossbars 120a, 120b and/or DSPs 110a, 110b, 110b, 110c, 110d may be selectively powered up and/or powered down based on traffic load. Alternatively or in addition, there may be per link optimization of transmission, receiving, and/or analog crossbar 120a, 120b power. Alternatively or in addition, the DSPs 110a, 110b, 110c, 110d may adjust power consumption based on a signal quality.

In some embodiments, power optimization may be refined at the per-link level, targeting the transmitter (Tx), receiver (Rx), and analog crossbar components. For example, the power state of each or individual links may be adjusted based on traffic intensity, priority, and link utilization. For example, a low-traffic link between DSP 110a and crossbar 120a operates in a low-power mode, reducing Tx and Rx power levels. In contrast, high-traffic links are configured for maximum performance, with full-power Tx and Rx states to ensure signal integrity.

In some embodiments, analog crossbars implement adaptive equalization to optimize power usage while maintaining signal quality. For example, equalization settings may be adjusted dynamically based on link distance and traffic type, reducing power consumption without compromising performance. This per-link optimization provides fine-grained control over power usage, enabling the system to achieve significant energy savings.

DSPs 110a, 110b, 110c, 110d may generate a predicted traffic load. The predicted traffic load may be generated using artificial intelligence and/or machine learning. Various machine learning algorithms may be used including one or more of linear regressions, logistic regression, decision trees, support vector machines, naïve Bayes classifiers, neural networks, clustering models, association rule models, time series models, or the like.

In some embodiments, traffic prediction may be enabled through statistical models that analyze historical traffic data and real-time metrics. For example, switch controller 130 may utilize predictive algorithms to forecast traffic patterns, such as peak usage periods or recurring congestion events. For example, system 100 may identify a pattern of increased traffic during specific times of the day and preemptively scale up resources to handle the anticipated demand.

In some embodiments, predictive traffic models may also enable dynamic queue adjustments in DSPs 110a-110d. For example, during predicted traffic surges, queue depths may be increased, and additional lanes are powered up to prevent bottlenecks. Conversely, during predicted low-traffic periods, the system conserves power by scaling down queues and deactivating unused resources.

DSPs 110a, 110b, 110c, 110d may adjust power consumption based on predicted traffic load. Statistical models for predicting traffic patterns may be used to preemptively adjust resources to handle spikes in demand.

DSPs 110a, 110b, 110c, 110d may power down one or more DSP 110a, 110b, 110c, 110d lanes based on the traffic load. Various methods for selectively powering down unused input/output lanes in crossbars may be used to conserve power when resources are not used. For example, as bandwidth drops, DSP 110a, 110b, 110c, 110d lanes may be selectively deactivated by the switch controller 130. Power may be saved in proportion to the number of lanes disabled.

DSPs 110a, 110b, 110c, 110d may asymmetrically power down one or more lanes based on traffic load. For example, DSPs 110a, 110b, 110c, 110d may activate more transmission lanes than receiving lanes, or DSPs 110a, 110b, 110c, 110d may activate more receiving lanes than transmission lanes.

DSPs 110a, 110b, 110c, 110d may scale resources when a predicted traffic increase occurs. Proactive scaling of resources based on predicted traffic increases may be used to provide resources when used while minimizing energy consumption.

DSPs 110a, 110b, 110c, 110d may communicate a power saving protocol using one or more of in-band signaling or out-of-band signaling. A DSP 110a, 110b, 110c, 110d to DSP 110a, 110b, 110c, 110d power saving protocol may be communicated e.g., through an out-of-band transceiver using redundant lanes. The DSP 110a, 110b, 110c, 110d to DSP 110a, 110b, 110c, 110d power saving protocol may quickly activate or deactivate lanes on the basis of bandwidth usage as requested by clients. The DSP 110a, 110b, 110c, 110d to DSP 110a, 110b, 110c, 110d power saving protocol may be communicated using in-band signaling. The reacquisition time may determine the amount of power that is saved.

The device in-band transceiver or auxiliary transceiver may optimize latency and/or power based on channel conditions for a selected connection. This may be facilitated by reducing equalization, data conversion resolution, processing resolution, or the like. A look-up table (LUT) used for crossbar configurations may be used to optimize latency and/or power based on the channel conditions.

In some embodiments, a device (e.g., an AECS 100) may include DSPs 110a, 110b, 110c, 110d, analog crossbars 120a, 120b, and/or a switch controller 130. The switch controller 130 may adjust power consumption based on a traffic load and/or signal quality. The switch controller 130 may generate a predicted traffic load. The switch controller 130 may adjust the power consumption based on predicted traffic load. The switch controller 130 may power down one or more DSP 110a, 110b, 110c, 110d lanes based on the traffic load. The switch controller 130 may asymmetrically power down one or more lanes based on traffic load. The switch controller 130 may scale resources when a predicted traffic increase occurs. The switch controller 130 may communicate a power saving protocol using one or more of in-band signaling or out-of-band signaling. In addition or alternatively, the AECS may be an optical circuit switch (OCS). Thus, any technique suitable for an AECS may be applied to an OCS.

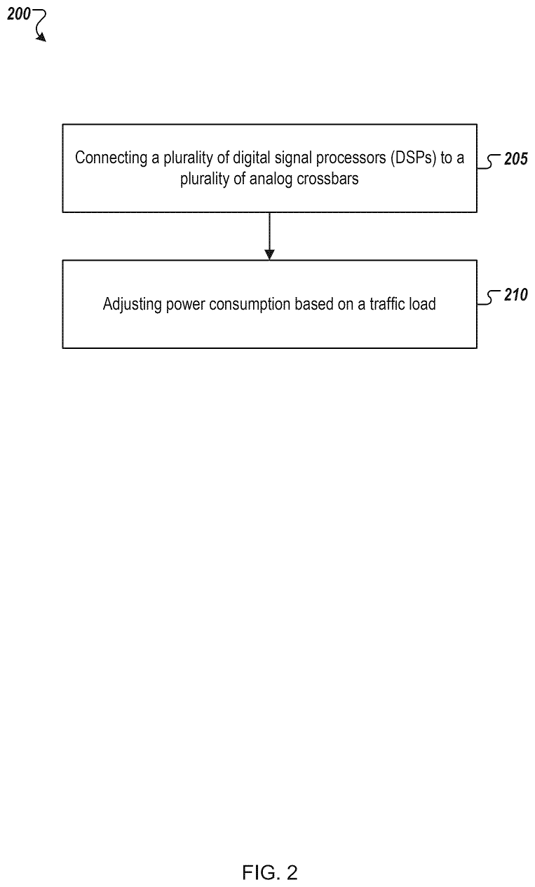

FIG. 2 illustrates a process flow of an example method 200 of adjusting power consumption, in accordance with at least one example described in the present disclosure. The method 200 may be arranged in accordance with at least one example described in the present disclosure.

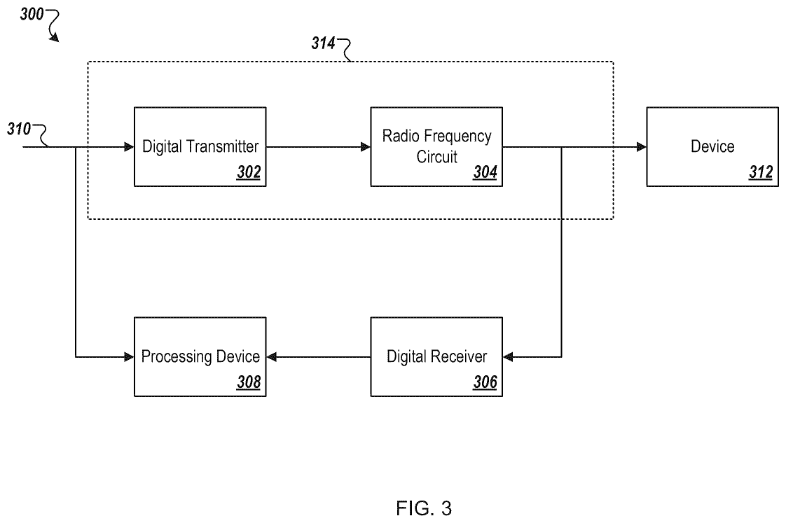

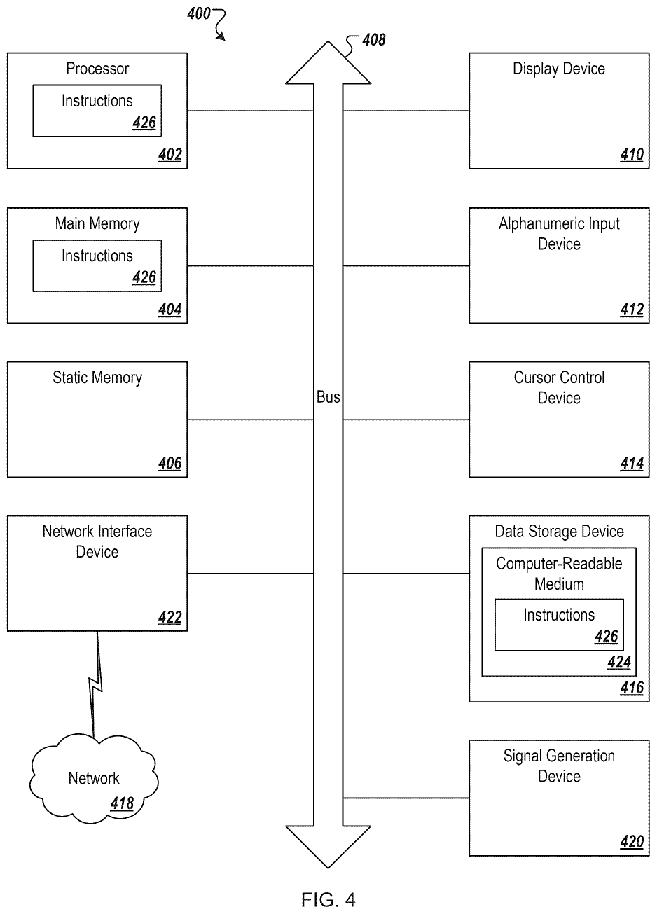

The method 200 may be performed by processing logic that may include hardware (circuitry, dedicated logic, etc.), software (such as is run on a computer system or a dedicated machine), or a combination of both, which processing logic may be included in the processing device 402 of FIG. 4, the communication system 300 of FIG. 3, or another device, combination of devices, or systems. The method 200 may begin at block 205 where the processing logic may connect DSPs to analog crossbars. At block 210, the processing logic may adjust power consumption based on a traffic load and/or signal quality.

The processing logic may generate a predicted traffic load. The processing logic may adjust the power consumption based on the predicted traffic load. The processing logic may power down one or more DSP lanes based on the traffic load. The processing logic may power down asymmetrically one or more lanes based on traffic load. The processing logic may scale resources when a predicted traffic increase occurs. The processing logic may communicate a power saving protocol using one or more of in-band signaling or out-of-band signaling.

Modifications, additions, or omissions may be made to the method 200 without departing from the scope of the present disclosure. For example, in some examples, the method 200 may include any number of other components that may not be explicitly illustrated or described.

### Energy Efficiency Metrics for Power Management

In some embodiments, the AECS system 100 incorporates energy efficiency metrics to evaluate and optimize power usage. As illustrated in FIG. 2, the switch controller 130 monitors key performance indicators (KPIs), such as watts per gigabit of data transferred, energy consumed per active lane, and system-wide power utilization per unit of traffic. These metrics provide a comprehensive understanding of power efficiency and guide adjustments to improve performance. For example, when the system detects a high watts-per-gigabit ratio on specific links, it dynamically reallocates traffic or adjusts power states to reduce energy consumption without compromising throughput.

In some embodiments, system 100 may also integrates real-time analytics to track these KPIs over time, enabling operators to identify trends and inefficiencies. For instance, historical data may reveal underutilized crossbars during specific traffic periods, prompting the system to implement targeted power-saving measures, such as powering down redundant lanes or lowering DSP operating voltages. In addition or alternatively, compute stack guidance may be used to predict traffic load.

In some embodiments, the DSPs 110a-110d and analog crossbars 120a-120b implement dynamic voltage and frequency scaling (DVFS) to further optimize power consumption. As shown in FIG. 1, the switch controller 130 dynamically adjusts the operating voltage and clock frequency of DSPs and crossbars based on real-time traffic demands and system conditions. For example, during periods of low traffic, the system reduces the operating voltage of DSPs 110a-110d, lowering power consumption while maintaining sufficient performance to handle active traffic.

Analog crossbars 120a-120b also benefit from DVFS by adjusting their internal clock frequencies and equalization settings. For instance, a crossbar handling intermittent traffic reduces its frequency to minimize power usage during idle periods. When traffic increases, the crossbar seamlessly transitions to a higher frequency and voltage state to accommodate the demand, ensuring that system performance is not compromised.

In some embodiments, DVFS is applied at the per-link level, allowing fine-grained control over individual connections between DSPs and crossbars. For example, as illustrated in FIG. 2, a high-priority link between DSP 110a and crossbar 120a operates at maximum voltage and frequency to ensure low-latency transmission. Conversely, low-priority or idle links are configured to operate in low-power states by reducing voltage and frequency. This adaptive approach ensures that power is distributed efficiently based on each link.

In some embodiments, system 100 leverages predictive traffic models to enhance the effectiveness of DVFS. For example, if a traffic surge is anticipated on specific links, the system preemptively increases the voltage and frequency of those connections, minimizing latency during peak usage. Similarly, during predicted low-traffic periods, links are proactively transitioned to lower power states to conserve energy.

In some embodiments, system 100 integrates energy efficiency metrics with DVFS to create a feedback loop for continuous optimization. As illustrated in FIG. 2, the switch controller 130 collects data on energy usage and system performance, comparing it to predefined efficiency thresholds. If the system detects deviations from expected performance, it adjusts voltage and frequency settings in real-time to restore optimal operation. For example, if a crossbar exhibits higher energy consumption than expected for its traffic load, the system recalibrates its DVFS parameters to reduce waste.

The techniques discussed above ensure that the AECS system achieves significant energy savings while maintaining high-speed data transmission and system reliability. By dynamically adjusting voltage and frequency and incorporating real-time metrics, the system optimizes power usage for peak and low-traffic scenarios.

In some embodiments, the AECS system 100 employs predictive algorithms to forecast traffic patterns and scale resources dynamically. As illustrated in FIG. 1, switch controller 130 analyzes historical traffic data and real-time metrics, such as queue depth, packet arrival rates, and link utilization, to identify trends and predict future demand. For example, if the system detects a recurring spike in traffic during specific hours, it preemptively activates additional DSP lanes and crossbar connections to handle the anticipated load.

Traffic prediction is enhanced by incorporating machine learning models, such as time series analysis and neural networks, to improve accuracy. For instance, a neural network model may identify complex patterns in multi-tenant environments, where traffic spikes vary across clients. This predictive capability ensures that resources are scaled proactively, reducing latency and preventing bottlenecks.

In some embodiments, the AECS system dynamically adjusts queue depths in DSPs 110a-110d based on predicted traffic surges. When a traffic increase is forecasted, switch controller 130 temporarily increases queue depths and allocates additional buffer space to handle the expected load. This preemptive scaling minimizes packet loss and ensures smooth data flow during peak periods. Conversely, during predicted low-traffic periods, the system conserves power by reducing queue depths and deactivating unused lanes. For example, when traffic predictions indicate a sharp drop in usage overnight, DSPs 110a-110d and crossbars 120a-120b transition to low-power states, saving energy without compromising performance. During, low-power states, idle patterns may be used for the lanes between ports. The idle patterns may have a higher error rate, e.g., 1E-3.

In some embodiments, the switch controller 130 implements proactive resource scaling to handle sudden traffic increases. For example, during a live-streaming event or data backup operation, the system rapidly activates additional DSP lanes and crossbar connections. By analyzing real-time traffic metrics, such as increased packet arrival rates or rising queue occupancy, the system ensures that sufficient resources are available before congestion occurs.

In some embodiments, proactive scaling may be complemented with system 100's ability to reprioritize traffic flows during surges. For instance, the switch controller dynamically adjusts traffic prioritization algorithms, such as weighted round-robin (WRR), to allocate bandwidth to high-priority flows while maintaining fairness for other traffic.

In some embodiments, adaptive scaling is achieved through machine learning models that refine predictions over time. For example, clustering algorithms identify patterns in traffic behavior across different system components, such as DSPs, crossbars, and endpoints. The system uses these insights to optimize resource allocation, ensuring that scaling decisions are accurate and efficient.

The system also incorporates feedback from real-time diagnostics to update machine learning models dynamically. For instance, if predictions overestimate traffic during specific hours, the system recalibrates its models to improve accuracy. This adaptive approach ensures that resources are scaled appropriately, minimizing energy consumption while maintaining performance.

Traffic prediction models are seamlessly integrated with dynamic voltage and frequency scaling (DVFS) to enhance power efficiency during scaling operations. As shown in FIG. 2, if a traffic surge is predicted, the system preemptively increases the voltage and frequency of DSPs 110a-110d and crossbars 120a-120b. This ensures that active components are operating at optimal performance levels to handle the increased load. Conversely, during predicted low-traffic periods, the system reduces voltage and frequency, conserving energy without compromising functionality. For example, when predictions indicate a brief traffic spike lasting a few minutes, the system scales resources temporarily and restores them to low-power states once the surge subsides. Such dynamic adjustment minimizes energy consumption while maintaining seamless operation.

In some embodiments, system 100 scales resources across multiple switches in large network deployments. Switch controller 130 may coordinate predictive traffic models for connected switches, ensuring that resources are balanced across the network. For instance, if one switch predicts a high traffic load, the system redistributes traffic to other switches with available capacity, reducing congestion and improving overall efficiency. Such traffic prediction and scaling techniques enable system 100 to adapt dynamically to varying network conditions, ensuring high performance, energy efficiency, and reliability. By leveraging machine learning, real-time diagnostics, and proactive scaling, system 100 achieves optimal resource utilization in complex networking environments.

In some embodiments, the AECS system 100 integrates traffic prioritization algorithms, such as weighted round-robin (WRR) and deficit weighted round-robin (DWRR), with power optimization techniques to maintain system efficiency during dynamic traffic conditions. As discussed above, the switch controller 130 uses real-time traffic metrics, such as queue depth and packet latency, to adjust priority levels dynamically. For example, during periods of congestion, high-latency traffic, such as real-time video streams, is prioritized over low-priority bulk transfers. This ensures that data is transmitted promptly, even as unused DSP lanes or crossbars are powered down to conserve energy.

In some embodiments, the switch controller 130 combines traffic prioritization with dynamic voltage and frequency scaling (DVFS). As shown in FIG. 2, when traffic prioritization algorithms identify high-priority data flows, the system adjusts the operating voltage and frequency of the corresponding DSP lanes and crossbars to ensure optimal performance. For example, if a latency-sensitive queue is detected in DSP 110a, the associated link to crossbar 120a is temporarily scaled up to full power to maintain low latency. Conversely, low-priority queues, such as bulk data backups, are routed through lower-power lanes, reducing overall energy consumption without compromising throughput for traffic.

In some embodiments, the AECS system 100 leverages prioritization algorithms to mitigate congestion while conserving power. During a traffic surge, the switch controller 130 activates additional DSP lanes and crossbar connections for high-priority flows, while selectively throttling or delaying low-priority traffic. This coordinated approach balances system load, prevents bottlenecks, and ensures that power-saving measures do not disrupt operations. For instance, if DSP 110b experiences a queue buildup, the system allocates additional power to its transmission lanes, enabling faster data clearance and reducing latency for high-priority traffic.

In some embodiments, traffic prioritization influences power-saving decisions during periods of underutilization. For example, when traffic metrics indicate low system activity, the switch controller 130 deactivates unused lanes or crossbars. High-priority traffic is then consolidated into active lanes, ensuring efficient bandwidth utilization while minimizing power usage. For example, if DSP 110c handles sporadic data requests, its low-priority lanes are deactivated, and its high-priority traffic is rerouted through active, low-latency connections.

The AECS system combines traffic prediction models with prioritization algorithms to scale resources proactively. For example, if a predicted traffic surge involves high-priority real-time communication, the system preemptively scales up DSP lanes and crossbars to meet latency. Conversely, if the surge consists primarily of low-priority bulk transfers, the system activates the minimum resources, maintaining energy efficiency without degrading user experience.

In multi-tenant data centers, traffic prioritization interacts with power scaling to optimize performance across clients. As illustrated in FIG. 1, the switch controller 130 assigns priority levels to each tenant based on service-level agreements (SLAs). High-priority tenants receive dedicated resources, such as full-power DSP lanes and crossbars, while low-priority tenants share remaining resources through scaled-down, low-power configurations. This ensures fairness and energy efficiency across tenants, even during peak traffic periods.

In some embodiments, the AECS system uses a feedback loop to refine prioritization and power-saving decisions dynamically. For example, real-time metrics from DSPs 110a-110d and crossbars 120a-120b are analyzed to evaluate the impact of prioritization on power usage and system performance. When a prioritization strategy results in excessive power consumption, system 100 adjusts power-saving policies, such as deactivating low-utilization lanes or reducing the operating frequency of low-priority links. This iterative process ensures optimal resource allocation while maintaining performance.

During crossbar reconfiguration events, the AECS system coordinates prioritization and scaling to maintain uninterrupted traffic flow. As shown in FIG. 2, the switch controller 130 temporarily prioritizes traffic flows and allocates sufficient power to active crossbars. Low-priority traffic is buffered or rerouted through alternate paths, minimizing disruptions. Once the reconfiguration is complete, the system restores normal prioritization and power-saving policies.

Such integrated features demonstrate the AECS system's ability to balance traffic prioritization, dynamic scaling, and power management, achieving high performance and energy efficiency in diverse and dynamic network environments. By coordinating these techniques, the system ensures that power-saving measures align with real-time traffic demands and prioritization.

In some embodiments, the AECS system 100 addresses potential latency impacts that may arise during power-saving transitions, such as when dynamic voltage and frequency scaling (DVFS) lowers voltage or clock frequency. As illustrated in FIG. 1, when DSPs 110a-110d or crossbars 120a-120b transition to lower power states, reduced processing speed may temporarily increase packet delays. For example, scaling down the frequency of crossbar 120b to conserve power may extend the time used to process high-priority traffic, impacting latency-sensitive applications.

To mitigate these impacts, in some embodiments, system 100 may employ preemptive scaling strategies based on predictive traffic models. As shown in FIG. 2, the switch controller 130 uses real-time traffic metrics and historical data to anticipate demand surges. For example, if a traffic spike is predicted for DSP 110c, the system preemptively increases its voltage and frequency before the surge begins, ensuring that latency remains within acceptable limits. This proactive approach minimizes the need for reactive scaling, reducing latency impacts during dynamic transitions. In addition or alternatively, compute stack guidance may be used to anticipate demand surges.

In some embodiments, DVFS parameters are dynamically adjusted based on latency. For example, the switch controller prioritizes maintaining low latency for traffic flows by selectively scaling resources associated with latency-sensitive queues. For example, if a high-priority video stream is routed through DSP 110a, system 100 ensures that its associated crossbar link operates at full power, even during low-traffic periods. This ensures that latency-sensitive traffic is unaffected while other low-priority connections operate in energy-saving states.

The system incorporates buffering mechanisms to minimize the impact of latency during power-saving transitions. For instance, when crossbar 120a transitions to a higher power state in response to a traffic surge, the switch controller temporarily buffers packets in DSP 110b's queue. This allows the crossbar to stabilize before processing the accumulated traffic, ensuring a smooth transition without packet loss or excessive latency.

In some embodiments, redundant crossbars are used to handle overflow traffic and ensure uninterrupted performance during scaling operations. As shown in FIG. 1, the AECS system 100 includes additional crossbars 120a-120b that remain in standby mode during normal operation. When the switch controller 130 detects increased traffic load, these redundant crossbars are selectively powered up to handle the overflow. For example, if crossbar 120a reaches its capacity, the system activates crossbar 120b to balance the load, preventing congestion and maintaining performance.

Redundant crossbars also play an advantageous role in scaling resources dynamically based on predicted traffic demand. As discussed above, the switch controller uses predictive traffic models to determine when additional crossbars will be used. For instance, if a surge in high-priority traffic is forecasted, the system activates a redundant crossbar in advance, ensuring sufficient capacity to handle the increase. Once the traffic subsides, the crossbar transitions back to a low-power state to conserve energy.

In some embodiments, redundant crossbars ensure seamless operation during crossbar reconfiguration events. For example, if crossbar 120b requires reconfiguration to accommodate a new routing policy, the switch controller reroutes traffic through a redundant crossbar, minimizing disruptions. This failover mechanism ensures that traffic flows remain uninterrupted while the reconfiguration is completed.

In some embodiments, AECS system 100 uses load-balancing algorithms to distribute traffic evenly across active and redundant crossbars, optimizing performance and power efficiency. For example, during periods of high traffic, the switch controller dynamically adjusts routing tables to spread the load across available crossbars. This approach minimizes congestion and maximizes system throughput while leveraging redundant resources effectively.

In some embodiments, redundant crossbars operate in low-power standby modes during periods of low traffic. As shown in FIG. 1, the system selectively activates these crossbars, reducing overall energy consumption. For example, if DSP 110d generates minimal traffic, its associated redundant crossbar remains deactivated until a traffic surge is detected.

Redundant crossbars may be seamlessly integrated with the system's traffic prediction models to enhance scalability. For instance, when a predicted traffic surge involves high-priority real-time communication, the system preemptively activates redundant crossbars to ensure sufficient bandwidth. This predictive approach reduces latency and avoids congestion, enabling the system to maintain performance under varying conditions.

For simplicity of explanation, methods and/or process flows described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

FIG. 3 illustrates a block diagram of an example communication system 300 operable for adjusting power consumption, in accordance with at least one example described in the present disclosure. The communication system 300 may include a digital transmitter 302, a radio frequency circuit 304, a device 312, a digital receiver 306, and a processing device 308. The digital transmitter 302 and the processing device may be configured to receive a baseband signal via connection 310. A transceiver 314 may comprise the digital transmitter 302 and the radio frequency circuit 304.

In some examples, the communication system 300 may include a system of devices that may be configured to communicate with one another via a wired or wireline connection. For example, a wired connection in the communication system 300 may include one or more Ethernet cables, one or more fiber-optic cables, and/or other similar wired communication mediums. Alternatively, or additionally, the communication system 300 may include a system of devices that may be configured to communicate via one or more wireless connections. For example, the communication system 300 may include one or more devices configured to transmit and/or receive radio waves, microwaves, ultrasonic waves, optical waves, electromagnetic induction, and/or similar wireless communications. Alternatively, or additionally, the communication system 300 may include combinations of wireless and/or wired connections. In these and other examples, the communication system 300 may include one or more devices that may be configured to obtain a baseband signal, perform one or more operations to the baseband signal to generate a modified baseband signal, and transmit the modified baseband signal, such as to one or more loads.

In some examples, the communication system 300 may include one or more communication channels that may communicatively couple systems and/or devices included in the communication system 300. For example, the transceiver 314 may be communicatively coupled to the device 312.

In some examples, the transceiver 314 may be configured to obtain a baseband signal. For example, as described herein, the transceiver 314 may be configured to generate a baseband signal and/or receive a baseband signal from another device. In some examples, the transceiver 314 may be configured to transmit the baseband signal. For example, upon obtaining the baseband signal, the transceiver 314 may be configured to transmit the baseband signal to a separate device, such as the device 312. Alternatively, or additionally, the transceiver 314 may be configured to modify, condition, and/or transform the baseband signal in advance of transmitting the baseband signal. For example, the transceiver 314 may include a quadrature up-converter and/or a digital to analog converter (DAC) that may be configured to modify the baseband signal. Alternatively, or additionally, the transceiver 314 may include a direct radio frequency (RF) sampling converter that may be configured to modify the baseband signal.

In some examples, the digital transmitter 302 may be configured to obtain a baseband signal via connection 310. In some examples, the digital transmitter 302 may be configured to up-convert the baseband signal. For example, the digital transmitter 302 may include a quadrature up-converter to apply to the baseband signal. In some examples, the digital transmitter 302 may include an integrated DAC. The DAC may convert the baseband signal to an analog signal, or a continuous time signal. In some examples, the DAC architecture may include a direct RF sampling DAC. In some examples, the DAC may be a separate element from the digital transmitter 302.

In some examples, the transceiver 314 may include one or more subcomponents that may be used in preparing the baseband signal and/or transmitting the baseband signal. For example, the transceiver 314 may include an RF front end (e.g., in a wireless environment) which may include a power amplifier (PA), a digital transmitter (e.g., 302), a digital front end, an Institute of Electrical and Electronics Engineers (IEEE) 1588v2 device, a Long-Term Evolution (LTE) physical layer (L-PHY), an (S-plane) device, a management plane (M-plane) device, an Ethernet media access control (MAC)/personal communications service (PCS), a resource controller/scheduler, and the like. In some examples, a radio (e.g., a radio frequency circuit 304) of the transceiver 314 may be synchronized with the resource controller via the S-plane device, which may contribute to high-accuracy timing with respect to a reference clock.

In some examples, the transceiver 314 may be configured to obtain the baseband signal for transmission. For example, the transceiver 314 may receive the baseband signal from a separate device, such as a signal generator. For example, the baseband signal may come from a transducer configured to convert a variable into an electrical signal, such as an audio signal output of a microphone picking up a speaker's voice. Alternatively, or additionally, the transceiver 314 may be configured to generate a baseband signal for transmission. In these and other examples, the transceiver 314 may be configured to transmit the baseband signal to another device, such as the device 312.

In some examples, the device 312 may be configured to receive a transmission from the transceiver 314. For example, the transceiver 314 may be configured to transmit a baseband signal to the device 312.

In some examples, the radio frequency circuit 304 may be configured to transmit the digital signal received from the digital transmitter 302. In some examples, the radio frequency circuit 304 may be configured to transmit the digital signal to the device 312 and/or the digital receiver 306. In some examples, the digital receiver 306 may be configured to receive a digital signal from the RF circuit and/or send a digital signal to the processing device 308.

In some examples, the processing device 308 may be a standalone device or system, as illustrated. Alternatively, or additionally, the processing device 308 may be a component of another device and/or system. For example, in some examples, the processing device 308 may be included in the transceiver 314. In instances in which the processing device 308 is a standalone device or system, the processing device 308 may be configured to communicate with additional devices and/or systems remote from the processing device 308, such as the transceiver 314 and/or the device 312. For example, the processing device 308 may be configured to send and/or receive transmissions from the transceiver 314 and/or the device 312. In some examples, the processing device 308 may be combined with other elements of the communication system 300.

FIG. 4 illustrates a diagrammatic representation of a machine in the example form of a computing device 400 within which a set of instructions, for causing the machine to perform any one or more of the methods discussed herein, may be executed. The computing device 400 may include a rackmount server, a router computer, a server computer, a mainframe computer, a laptop computer, a tablet computer, a desktop computer, or any computing device with at least one processor, etc., within which a set of instructions, for causing the machine to perform any one or more of the methods discussed herein, may be executed. In alternative examples, the machine may be connected (e.g., networked) to other machines in a local area network (LAN), an intranet, an extranet, or the Internet. The machine may operate in the capacity of a server machine in client-server network environment. Further, while only a single machine is illustrated, the term “machine” may also include any collection of machines that individually or jointly execute a set (or multiple sets) of instructions to perform any one or more of the methods discussed herein.

The example computing device 400 includes a processing device (e.g., a processor) 402, a main memory 404 (e.g., read-only memory (ROM), flash memory, dynamic random access memory (DRAM) such as synchronous DRAM (SDRAM)), a static memory 406 (e.g., flash memory, static random access memory (SRAM)) and a data storage device 416, which communicate with each other via a bus 408.

Processing device 402 represents one or more general-purpose processing devices such as a microprocessor, central processing unit, or the like. More particularly, the processing device 402 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 402 may also include one or more special-purpose processing devices such as an application specific integrated circuit (ASIC), a field programmable gate array (FPGA), a DSP, network processor, or the like. The processing device 402 is configured to execute instructions 426 for performing the operations and steps discussed herein.

The computing device 400 may further include a network interface device 422 which may communicate with a network 418. The computing device 400 also may include a display device 410 (e.g., a liquid crystal display (LCD) or a cathode ray tube (CRT)), an alphanumeric input device 412 (e.g., a keyboard), a cursor control device 414 (e.g., a mouse) and a signal generation device 420 (e.g., a speaker). In at least one example, the display device 410, the alphanumeric input device 412, and the cursor control device 414 may be combined into a single component or device (e.g., an LCD touch screen).

The data storage device 416 may include a computer-readable storage medium 424 on which is stored one or more sets of instructions 426 embodying any one or more of the methods or functions described herein. The instructions 426 may also reside, completely or at least partially, within the main memory 404 and/or within the processing device 402 during execution thereof by the computing device 400, the main memory 404 and the processing device 402 also constituting computer-readable media. The instructions may further be transmitted or received over a network 418 via the network interface device 422.

While the computer-readable storage medium 424 is shown in an example to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

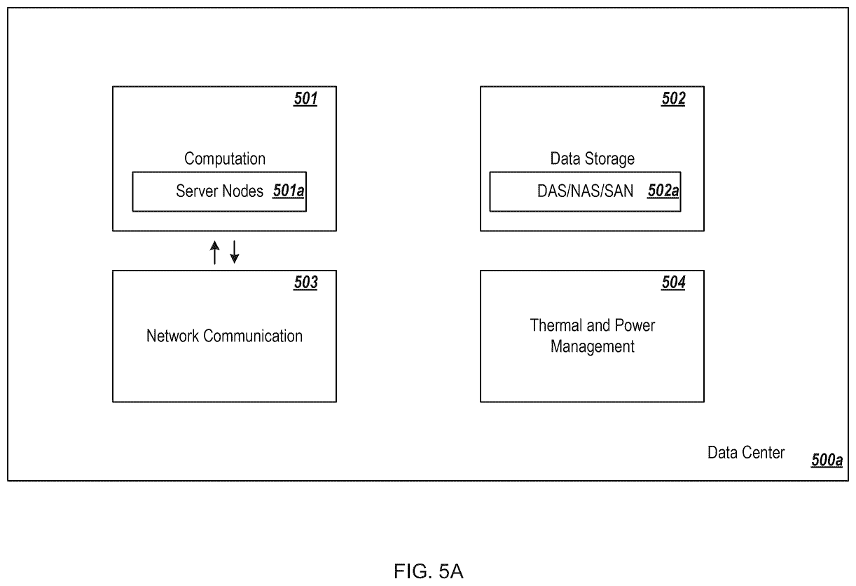

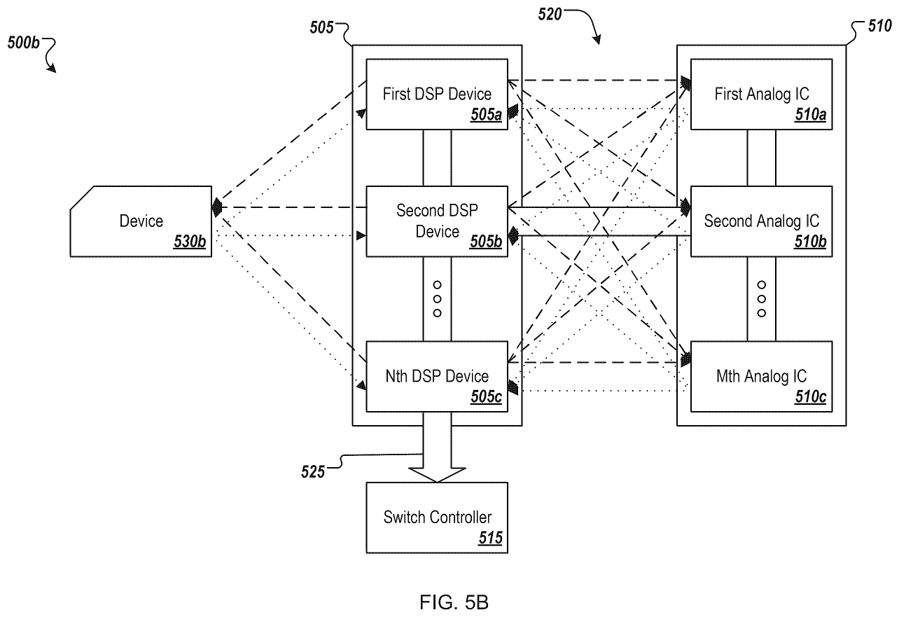

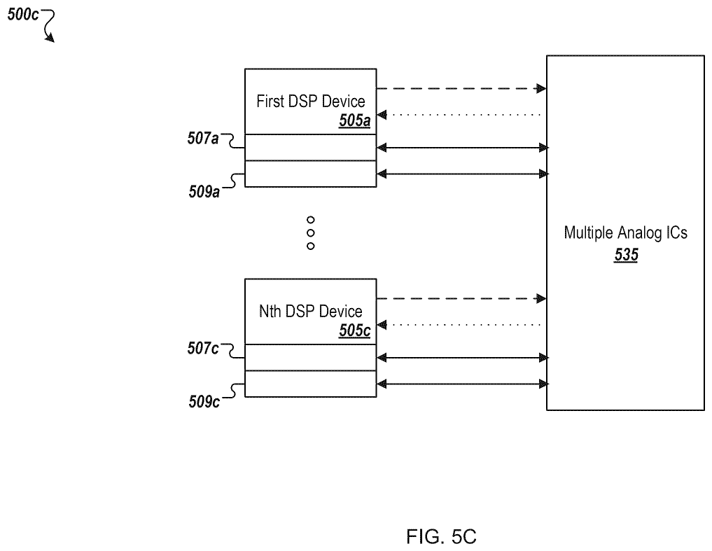

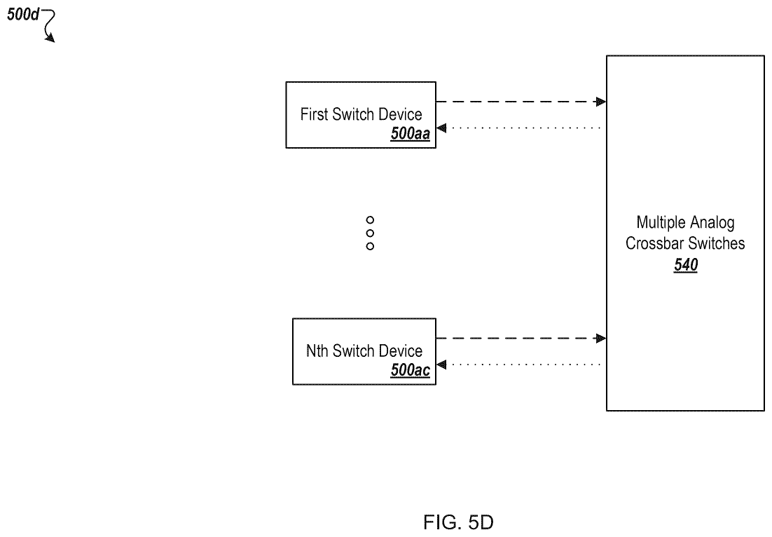

As illustrated in FIG. 5A, a block diagram of a data center 500a may include multiple subsystems configured to perform various operational functions, including computation 501, data storage 502, network communication 503, and thermal and power management 504. The computation 501 subsystem may include one or more server nodes 501a that may execute software applications and process data workloads. The data storage 502 subsystem may provide persistent data retention through devices such as hard disk drives, solid-state drives, or distributed storage arrays, which may be organized in configurations such as Direct Attached Storage (DAS), Network Attached Storage (NAS), or Storage Area Networks (SAN) 502a. The networking communication 503 subsystem may facilitate bidirectional data transfer between servers and external networks through high-speed switching and routing components. The thermal and power management 504 subsystem may maintain operational integrity by regulating temperature and supplying uninterrupted electrical power, e.g., through redundant power sources and cooling mechanisms. Each subsystem may operate in coordination to ensure continuous availability, scalability, and fault tolerance and the ability to scale up and scale out in response to increasing computational and storage demands.

The architecture of a data center 500a may include multiple physical and logical components that collectively enable high-performance computing and data handling. The compute layer may include server racks populated with processors optimized for general-purpose or specialized workloads, including central processing units (CPUs), graphics processing units (GPUs), and field-programmable gate arrays (FPGAs). The storage layer may incorporate hierarchical storage systems that may employ high-speed interfaces such as Non-Volatile Memory Express (NVMe) to reduce latency. The networking layer may use top-of-rack switches, aggregation switches, and core routers arranged in various topologies, (e.g., crossbar, Clos, leaf-spine, etc.) to provide non-blocking connectivity and minimize hop count between endpoints. Power distribution units (PDUs), uninterruptible power supplies (UPS), and backup generators may form the electrical infrastructure, while cooling systems may employ air-based or liquid-based heat dissipation techniques to maintain thermal stability. These components may be integrated to achieve high reliability, modular scalability, and compliance with performance, enabling the system to scale up and scale out as operational loads increase.

In operation, a data center may process client requests through a multi-stage workflow that includes traffic distribution, application execution, and data retrieval. Incoming requests may be received by a load balancing system configured to allocate workloads across multiple compute nodes to prevent resource saturation. Application servers may execute the requested operations, which may involve accessing structured or unstructured data stored within the storage subsystem. Virtualization technologies may enable multiple virtual machines to operate on a single physical server, thereby optimizing resource utilization. Containerization frameworks, such as those implementing Linux containers, may provide isolated execution environments for microservices and facilitate rapid deployment across heterogeneous hardware. The networking subsystem may ensure deterministic packet routing and congestion management through high-speed interconnects and software-defined networking protocols. This operational workflow may be designed to maintain low latency, high throughput, and fault-tolerant performance under variable load conditions, while supporting the ability to scale up and scale out dynamically.

Conventional data center implementations may exhibit several advancements aimed at improving efficiency, scalability, and sustainability. Hyperscale architectures may employ large-scale server clusters interconnected through high-bandwidth fabrics to support cloud computing and artificial intelligence workloads. Edge computing deployments may position micro data centers proximate to end-user devices to reduce network latency and enable real-time processing. Specialized accelerators, including GPUs and tensor processing units (TPUs), may be increasingly integrated to support machine learning and high-performance computing applications. Energy efficiency initiatives may incorporate renewable energy sources and advanced cooling methodologies, such as liquid immersion cooling, to reduce operational costs and environmental impact. These trends reflect an industry-wide transition toward architectures that may be highly distributed, workload-optimized, and environmentally sustainable.

A scale-up network architecture may be characterized by the addition of resources within a single network node or chassis to increase capacity. In such configurations, performance improvements may be achieved by augmenting the processing capability, memory, or port density of an existing switch or router. This approach may involve deploying high-capacity modular switches with vertically integrated backplanes and high-bandwidth switch fabrics. The scale-up model may be advantageous for environments having centralized control and minimal inter-node latency, as traffic may be processed within a single logical device.

A scale-out network architecture may be characterized by the horizontal expansion of network capacity through the addition of multiple interconnected nodes. In this configuration, performance and scalability may be achieved by distributing workloads across multiple switches, for example arranged as a leaf-spine architecture. Each leaf switch may provide connectivity to compute and storage resources, while spine switches interconnect the leaf layer to form a non-blocking, high-bandwidth fabric. The scale-out model may enable incremental capacity expansion without replacing existing infrastructure, thereby supporting elastic growth and fault tolerance. This architecture may be particularly suited for large-scale data centers and cloud environments, where traffic patterns may be highly distributed and use predictable bandwidth. Scale-out networks may leverage parallelism and redundancy to achieve near-linear scalability.

A scale-up network may carry information, including AI training and inference algorithms, among computing units (such as graphics processing units (GPUs)). These networks may have various characteristics such as high bandwidth (e.g., non-blocking all-to-all bandwidth), low latency (e.g., minimize layers of switching and per-switch latency), and scalability (e.g., supporting high numbers of interconnected GPUs and low energy per bit transferred through network). For purposes of this disclosure, a “GPU” has been provided as an example and instances of GPU may be substituted by any type of processor such as CPUs, ASICs, or the like.

Conventional scale-up networks may centralize the switching/routing function in order to scale GPU connectivity across multiple rack units and even multiple racks. An example compute rack may include 18 compute trays consuming about 6 kW each, and 9 switch trays consuming about 1 kW each. Each GPU may have 18 ports of 100 GB/s each (or 1.8 TB/s per GPU), and the rack network (which may be implemented using a copper backplane) may connect each GPU to the 9 switch trays to provide each GPU with the ability to deliver its 1.8 TB/s to any other GPU in the rack, a capability often referred to as “All-to-All bandwidth”. This may be used for parallelizing the computation of an AI model for training or inference purposes.

This rack-level power density may be quite high and push the limit of electrical power and thermal cooling densities, leaving little room for additional compute trays. Furthermore, switch connectivity for all-to-all crossbar-like functionality has complexity and power which may vary quadratically with the number of ports being interconnected, so scaling the GPUs connected within a rack may be constrained, even when the number of GPUs may be increased.

A centralized full crossbar may be replaced with distributed crossbars which places ultra-efficient, ultra-low-latency analog crossbars locally with their respective GPUs, and routes them to digital switch system on chips (SOCs) with an arrangement of crossbars which may be simplified compared with full crossbars. This may drive improvements in network power, latency, complexity, and scalability.

As a result, network traffic (e.g., which may be AI traffic) may be matched with low predictable latency providing all-to-all bandwidth. Compared to Ethernet packet switches, ⅕ of the power may be consumed. The device may be capable of high radix implementations (e.g., 1024 lanes). The device may be usable in all-copper backplane scale ups as well as with multi-mode (MM) fiber.

Thus, the examples described herein present systems and methods for an Analog Electrical Circuit Switch (AECS) switch capable of ultra-low-latency (e.g., <5 ns, 10 ns, or the like) and low-power switching across a flexible any-to-any crossbar architecture. The AECS switch eliminates internal buffering and packet inspection within the crossbar, allowing for a highly efficient and scalable architecture. A programmable crossbar configuration may dynamically map input ports to output ports in response to real-time traffic conditions.

An example system may include advanced control mechanisms for broadcasting and multicasting data from a single input to multiple outputs, optimizing resource allocation and minimizing overhead. Make-before-break (MBB) protocols may be employed to ensure seamless reconfiguration of crossbar connections without data loss, even during high-speed operations. Additionally, adaptive equalization techniques may be integrated into the system, allowing the AECS to optimize signal quality based on feedback from connected devices.

An architecture may include redundancies along with digital signal processors (DSPs) configured to support any-to-any connections. In such an arrangement, low-latency switching along with low power use per lane may be achieved. Further, memory included in the DSPs may be used for any storage or buffering and each of the components included in the switch may include redundant lanes such that degradations or broken DSPs may be rerouted around and replaced without losses to the system. The reconfiguration in the switch may be dynamically performed (e.g., such as in view of real-time traffic managed by the switch) by a switch controller that may communicate with the components in the switch using out-of-band traffic so as to not interfere with the in-band communications otherwise being handled by the switch.

FIG. 5B illustrates an example switch device 500b. The switch device 500b may include a first digital signal processor (DSP) device 505a, a second DSP device 505b, an nth DSP device 505c, referred to collectively as multiple first electronic devices 505, a first analog integrated circuit (IC) 510a, a second analog IC 510b, an mth analog IC 510c, referred to collectively as multiple second electronic devices 510, a switch controller 515, in-band traffic 520, and out-of-band traffic 525. First DSP 505a, second DSP 505b, and nth DSP 505c may have input and output.

The switch device 500b may be reconfigurable (e.g., in terms of the connections between the components therein, such as the multiple first electronic devices 505 and the multiple second electronic devices 510, the switch controller 515, and/or a device 530), where the switching of the connections/lanes between the components may be low latency (e.g., less than 5 ns, 10 ns, or the like switching). Alternatively, or additionally, the switch device 500b may reconfigure without the use of retiming such that each lane of the multiple lanes included therein may use less than 50 mW of power. For example, each lane of the multiple lanes may support 100G bandwidth while using less than 50 mW of power.

The multiple first electronic devices 505 may individually include one or more ports that may be used to facilitate communications within the switch device 500b, such as between the multiple first electronic devices 505 and the multiple second electronic devices 510, the switch controller 515, and/or a device 530. The communications in the switch device 500b may be transmitted via multiple lanes in the switch device 500b. The multiple lanes may facilitate the in-band traffic 520 and/or the out-of-band traffic 525.

The multiple lanes between the multiple first electronic devices 505 and the multiple second electronic devices 510 may be in an any-to-any configuration. For example, the first DSP device 505a may include a lane to the first analog IC 510a, to the second analog IC 510b, and/or the mth analog IC 510c. A similar arrangement may occur for each of the multiple first electronic devices 505, such that each DSP device of the multiple first electronic devices 505 may include a lane to any number of the multiple second electronic devices 510, including none of the multiple second electronic devices 510. Each lane for facilitating the in-band traffic 520 may be in both directions (e.g., transmit and receive) between the multiple first electronic devices 505, the multiple second electronic devices 510, and/or a device 530. Alternatively, or additionally, the lanes are dashed/dotted to illustrate that for any transmit/receive path between the multiple first electronic devices 505, the multiple second electronic devices 510, and/or a device 530, a lane may or may not be present.

The multiple first electronic devices 505, the multiple second electronic devices 510, and/or the switch controller 515 may be disposed on a printed circuit board (PCB) where traces on the PCB may be used to connect at least the multiple first electronic devices 505, the multiple second electronic devices 510, and/or the switch controller 515 (e.g., the traces on the PCB may facilitate the in-band traffic 520 and/or the out-of-band traffic 525 in the switch device 500b). Alternatively, or additionally, the multiple first electronic devices 505, the multiple second electronic devices 510, and/or the switch controller 515 may be connected to one another using connectors, such as high-speed cables, where the multiple first electronic devices 505, the multiple second electronic devices 510, and/or the switch controller 515 may individually include ports/headers to support the use of the connectors. In instances in which the connectors are used, crosstalk between the multiple lanes in the switch device 500b may be reduced relative to the crosstalk that may occur when the switch device 500b uses traces on a PCB.

The switch device 500b, including the multiple first electronic devices 505, the multiple second electronic devices 510, and/or the switch controller 515, may be utilized with one or more additional switches and/or crossbar devices to form a new crossbar switch device, which may be larger than any one of the switch devices 500b. For example, as illustrated and discussed relative to FIG. 5C, the switch device 500b may be utilized with any other number of switch devices 500b (e.g., the nth switch device 500ac in FIG. 5C) and multiple analog crossbar switches 540 to form a new crossbar switch device.

The multiple first electronic devices 505 may be digital signal processors (DSPs) and/or the multiple second electronic devices 510 may be analog circuit switch integrated circuits (ICs) for use with electrical signals. Alternatively, or additionally the multiple second electronic devices 510 may be analog optical circuit switch ICs for use with optical signals. The multiple first electronic devices 505 may be individually configured to support one or more layer of the open systems interconnection (OSI) model. For example, each of the multiple first electronic devices 505 may be configured to support layer 1 protocols, layer 2 protocols, and/or layer 3 protocols with respect to the in-band traffic 520 and/or the out-of-band traffic 525.

Each, or at least one, of the multiple first electronic devices 505 may support layer 1 protocols, which may include detecting and/or processing layer 2 protocols and/or layer 3 protocols, handling layer 2 protocol and/or layer 3 protocol addressability, frame header detection, packet header inspection, responding to layer 2 protocol and/or layer 3 protocol requests, storing information in response to a request associated with layer 2 protocols and/or layer 3 protocols, updating information in response to a request associated with layer 2 protocols and/or layer 3 protocols, communicating information in response to a request associated with layer 2 protocols and/or layer 3 protocols, optimizing information in response to a request associated with layer 2 protocols and/or layer 3 protocols, etc. Each of the multiple first electronic devices 505 may be able to adjust the way in which traffic is directed through it, such as in response to a command from the switch controller 515. For example, each of the multiple first electronic devices 505 may be operable to configure an internal switch, an external switch, or a crossbar based on the various layer protocol processing to be performed.

The first DSP device 505a may receive a communication that includes a frame header (or a packet header) and the first DSP device 505a may be configured to detect the frame header and decode the frame header along with any associated contents of the communication, within the first DSP device 505a. In a second example, the first DSP device 505a may integrate a media access control (MAC) address lookup table which may allow the first DSP device 505a to configure one or more crossbars such that the first DSP device 505a may facilitate connectivity between any two MAC addresses that are included in the lookup table. Alternatively, or additionally, each of the first electronic devices 505 may include a lookup table that may store equalization settings that may be used for various connections between the first electronic devices 505 and other components within the switch device 500b. The equalization settings in the lookup table may be used to accelerate acquisition and/or tracking for a particular DSP device of the multiple first electronic devices 505 when the particular DSP device switches connections within the switch device 500b.

The multiple first electronic devices 505 may be configured to respond to layer 2 protocol requests and/or layer 3 protocol requests for connectivity and/or resource grant requests. For example, the multiple first electronic devices 505 may compare a request to a lookup table that includes priority levels and the multiple first electronic devices 505 may be operable to configure themselves and/or associated crossbars and/or switches based on the determined priority level. Alternatively, or additionally, each of the multiple first electronic devices 505 may be configured to respond to in-band requests (e.g., granting a connection request, signaling backpressure to the device 530, etc.), collect statistics on traffic handled by the multiple first electronic devices 505 (e.g., link utilization and/or traffic type), and/or perform data filtering (e.g., detecting a particular header, performing routing, generating flags and/or interrupts, and/or logging any of the filtering events).

The multiple first electronic devices 505 may be configured to communicate with (e.g., transmit data to and/or receive data from) the device 530. The communication with the device 530 may include in-band traffic 520. In such instances, the communications between the multiple first electronic devices 505 and the device 530 may be line-side communications, where the lines may facilitate communications using various communication channels. For example, the line-side communications between the multiple first electronic devices 505 and the device 530 may be an electrical-to-electrical connection, an optical-to-optical connection, an electrical-to-optical connection, or an optical-to-electrical connection, and so forth.

The device 530 may address communications directly to one of the multiple first electronic devices 505. For example, the device 530 may address communications to the second DSP device 505b. Alternatively, or additionally, the device 530 may address communications to the switch controller 515, which may then direct communications to the appropriate DSP device. For example, the device 530 may address communications intended for the second DSP device 505b to the switch controller 515 and the switch controller 515 may direct the communications to the second DSP device 505b.

The multiple first electronic devices 505 may individually include memory that may be used as a buffer for communications through the multiple first electronic devices 505. The memory in the multiple first electronic devices 505 may be utilized to buffer incoming and/or outgoing traffic, which may include in-band traffic 520 and/or out-of-band traffic 525. Due to the memory in the multiple first electronic devices 505 being distributed (e.g., by the distributed nature of the multiple first electronic devices 505), the switch device 500b may not include any memory for buffering in addition to the memory included in the multiple first electronic devices 505.

The multiple first electronic devices 505 may individually include one or more additional lanes that may be used for communications in the switch device 500b. Further details associated with the additional lanes are included in the description associated with FIG. 5C.

The multiple second electronic devices 510 may individually include one or more ports that may be used to facilitate communications within the switch device 500b, similar to the ports described relative to the multiple first electronic devices 505. Alternatively, or additionally, the lanes for communications between the multiple first electronic devices 505 and the multiple second electronic devices 510 may be coupled with the ports included in the multiple second electronic devices 510.

The switch controller 515 may be a microcontroller unit (MCU). Alternatively, or additionally, the switch controller 515 may be a DSP, or other processing device. The switch controller 515 may be communicatively coupled with at least the multiple first electronic devices 505 and/or the multiple second electronic devices 510. The switch controller 515 may resolve resource grant requests, distribute the network state to the multiple first electronic devices 505 and/or to the multiple second electronic device 510, and/or may establish and/or maintain timing among the components included in the switch device 500b.

The switch controller 515 may communicate with the multiple first electronic devices 505 and/or the multiple second electronic devices 510 using a separate connection/lane than the connections between the multiple first electronic devices 505 and the multiple second electronic devices 510. For example, the first connection between the multiple first electronic devices 505 and the multiple second electronic devices 510 may facilitate the in-band traffic 520 and the second connection between the switch controller 515 and the multiple first electronic devices 505 and/or the multiple second electronic devices 510 may facilitate the out-of-band traffic 525.

The out-of-band traffic 525 may use a different network than the in-band traffic 520. Alternatively, or additionally, the out-of-band traffic 525 may use a different physical layer protocol than the in-band traffic 520. The out-of-band traffic 525 may be used to manage and/or configure one or more components included in the switch device 500b. For example, the switch controller 515 may communicate with the multiple first electronic devices 505 using the out-of-band traffic 525 to reconfigure lanes and/or traffic routing based on the traffic through the switch device 500b.

The switch controller 515 may be programmable such that the switch controller 515 may be operable to dynamically map the lanes between the multiple first electronic devices 505 and the multiple second electronic devices 510. For example, in instances in which the first DSP device 505a includes a lane to the first analog IC 510a, the switch controller 515 may dynamically map the lane to be from the first DSP device 505a to the second analog IC 510b. The switch controller 515 may dynamically adapt the mapping of the lanes between the multiple first electronic devices 505 and the multiple second electronic devices 510 based on one or more conditions and/or a satisfaction of a threshold related to the conditions. For example, in instances in which the real-time data traffic in the switch device 500b (or an amount of real-time data traffic handled by one of the multiple first electronic devices 505 and/or one of the multiple second electronic devices 510) satisfies a threshold, the switch controller 515 may dynamically adapt the mapping of the lanes as described.

The switch device 500b may include one or more redundant lanes that may be used in various situations during operation of the switch device 500b. For example, one or more redundant lanes may be used for the out-of-band traffic 525, such as signaling using the out-of-band traffic 525. In such instances, the out-of-band signaling may be transmitted and/or received by a particular DSP device and/or by the switch controller 515, and the out-of-band signaling may be a lower transmission rate than the in-band traffic 520. In another example, one or more redundant lanes may be used for out-of-bandwidth broadcasts from the switch controller 515 and/or from one or more of the multiple first electronic devices 505 to other devices in the switch device 500b (e.g., such as other DSP devices).

The switch controller 515 may reserve a portion of bandwidth associated with the in-band traffic 520 in the switch device 500b. The bandwidth reserved by the switch controller 515 may be reserved on a per lane basis of the multiple lanes included in the switch device 500b. For example, a first lane between the first DSP device 505a and the first analog IC 510a may have a first reserved bandwidth and a second lane between the second DSP device 505b and the second analog IC 510b may have a second reserved bandwidth, where the amount of bandwidth reserved may be the same or may differ between the first reserved bandwidth and the second reserved bandwidth. The switch controller 515 may allocate resources within the switch device 500b based on predicted or anticipated traffic (e.g., based on a probabilistic model).

Alternatively, or additionally, the switch controller 515 may monitor the lanes of the multiple lanes in the switch device 500b. The switch controller 515 may monitor the multiple lanes periodically and/or in a round robin manner, such that the lanes of the multiple lanes may observed to determine if failures or degradations may be present in a lane. In instances in which a lane experiences a degradation that satisfies a threshold for an acceptable loss, the switch controller 515 may dynamically remap a new lane in the switch device 500b to replace the degraded lane.

The switch controller 515 may perform adaptive signal equalization to the in-band traffic 520 in the switch device 500b. For example, the multiple first electronic devices 505 may provide feedback to the switch controller 515 relative to the workload handled by the multiple first electronic devices 505, and the switch controller 515 may adaptively manage workloads of the multiple first electronic devices 505 to optimize performance of the switch device 500b.

A backup switch controller (not illustrated) may be included in the switch device 500b. The backup switch controller may be a redundant controller relative to the switch controller 515. The backup switch controller may include the same or similar connections as the switch controller 515 relative to the multiple first electronic devices 505 and/or the multiple second electronic devices 510. The backup switch controller may perform the same or similar operations as the switch controller 515.

FIG. 5C illustrates an example switch device 500c. The switch device 500c may include a first DSP device 505a, an nth DSP device 505c, and multiple analog ICs 535. The first DSP device 505a may include a first auxiliary channel 507a, and a first out-of-band channel 509a. The nth DSP device 505c may include an nth auxiliary channel 507c, and an nth out-of-band channel 509c.

The first DSP device 505a, the nth DSP device 505c, and the multiple analog ICs 535 may be the same or similar as the first DSP device 505a, the nth DSP device 505c, and the multiple second electronic devices 510, respectively, of FIG. 5A and may be operable to perform the same or similar functions as described.

The auxiliary channels 507 (e.g., the first auxiliary channel 507a and the second auxiliary channel 507c) may be individually utilized by each of the DSP devices 505a, 505c as an additional lane for in-band traffic between at least the DSP devices 505a, 505c and the multiple analog ICs 535. The auxiliary channels 507 may be used to redundantly transmit in-band traffic relative to another lane included in the DSP devices 505a, 505c prior to a change in configuration to the corresponding DSP devices 505a, 505c. For example, in instances in which the first DSP device 505a includes a lane to a particular analog IC of the multiple analog ICs 535 and the first DSP device 505a is to be reconfigured (e.g., by a switch controller as described herein), the first auxiliary channel 507a may have a lane mapped to the particular analog IC such that the in-band traffic is redundant between the first DSP device 505a and the particular analog IC prior to reconfiguring the lanes associated with the first DSP device 505a (which reconfiguration may otherwise break the connection between the first DSP device 505a and the particular analog IC).

The auxiliary channels 507 may be used for communication between other near DSP devices. For example, in instances in which the first DSP device 505a is disposed spatially near to the nth DSP device 505c, the first DSP device 505a and the nth DSP device 505c may communicate with one another via the auxiliary channels 507. Such communications may be possible as the channels between near-neighbors may be relatively clean, such that physical layer processing may be simplified and may result in power reduction, latency reduction, a lesser amount of equalization, and/or other benefits to the switch device 500c.

The out-of-band channels 509 may be used to communicate the out-of-band traffic (e.g., the out-of-band traffic 525 of FIG. 5B) on a lane separate from the multiple lanes used to communicate in-band traffic. In such instances, the out-of-band channels 509 may not cause blocking or interference to the in-band traffic between at least the DSP devices 505a, 505c and the multiple analog ICs 535.

FIG. 5D illustrates an example aggregated switch device 500d. The aggregated switch device 500d may include a first switch device 500aa, an nth switch device 500ac, and multiple analog crossbar switches 540. The first switch device 500aa and the nth switch device 500ac may individually be the same or similar as the switch device 500b of FIG. 5B.

The aggregated switch device 500d illustrates that any number of the switch devices 500b (e.g., the first switch device 500aa and the nth switch device 500ac) may be aggregated into another switch device and/or connected to other analog crossbar switches. Each of the switch devices 500b may include multiple DSP devices and multiple analog IC and may be further aggregated into the aggregated switch device 500d using the multiple analog crossbar switches 540. As such, the aggregated switch device 500d may be scaled up or down for any size communication need, by adjusting the switch devices 500b and/or the multiple analog crossbar switches 540 to meet the communication demand.

### EXAMPLES

In one example, a method may include activating redundant crossbars to handle overflow traffic during scaling operations or failover scenarios. In another example, a method may include transitioning redundant crossbars between low-power standby and active states based on predicted or real-time traffic demand. In another example, a method may include integrating traffic prioritization algorithms, including weighted round-robin (WRR) or deficit weighted round-robin (DWRR), to allocate power and bandwidth dynamically to high-priority traffic flows. In another example, a method may include coordinating power-saving transitions with traffic prioritization to minimize latency impacts for high-priority traffic flows.

In some examples, the different components, modules, engines, and services described herein may be implemented as objects or processes that execute on a computing system (e.g., as separate threads). While some of the systems and methods described herein are generally described as being implemented in software (stored on and/or executed by hardware), specific hardware implementations or a combination of software and specific hardware implementations are also possible and contemplated.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although examples of the present disclosure have been described in detail, it should be understood that the various changes, substitutions, and alterations could be made hereto without departing from the spirit and scope of the present disclosure.

What is claimed is:

1. A device, comprising:
a plurality of digital signal processors (DSPs);
a plurality of analog crossbars in communication with the plurality of DSPs; and
a switch controller operable to dynamically adjust power consumption of the plurality of DSPs and the plurality of analog crossbars based on a traffic load.

2. The device of claim 1, wherein the switch controller is further operable to predict a traffic load using real-time metrics, historical traffic data, or compute stack guidance.

3. The device of claim 2, wherein the switch controller is operable to adjust power consumption of the plurality of DSPs and the plurality of analog crossbars based on the predicted traffic load.

4. The device of claim 1, wherein the plurality of DSPs are operable to power down one or more input/output lanes based on the traffic load to conserve energy.

5. The device of claim 1, wherein the plurality of DSPs are operable to asymmetrically power down one or more transmission lanes or receiving lanes based on the traffic load.

6. The device of claim 1, wherein the switch controller is operable to preemptively scale resources, including DSP lanes, crossbars, or voltage supplies for the DSP lanes or the crossbars, in response to a predicted traffic increase.

7. The device of claim 1, wherein the plurality of DSPs are operable to communicate a power-saving protocol using one or more of in-band signaling or out-of-band signaling to optimize resource allocation dynamically.

8. The device of claim 1, wherein the switch controller integrates traffic prioritization algorithms, including weighted round-robin (WRR) or deficit weighted round-robin (DWRR), to allocate power and bandwidth to high-priority traffic flows.

9. The device of claim 1, wherein the switch controller is operable to dynamically adjust voltage and frequency of the plurality of DSPs and the plurality of analog crossbars to optimize power consumption based on link utilization and traffic priority.

10. The device of claim 1, further comprising redundant crossbars operable to handle overflow traffic during scaling operations or failover scenarios.

11. The device of claim 10, wherein the redundant crossbars are operable to transition between low-power standby and active states based on predicted or real-time traffic demand.

12. The device of claim 1, wherein the plurality of DSPs and the plurality of analog crossbars are operable to coordinate power-saving transitions with traffic prioritization to minimize latency impacts for high-priority traffic flows.

13. A method, comprising:
connecting a plurality of digital signal processors (DSPs) to a plurality of analog crossbars; and
dynamically adjusting power consumption of the plurality of DSPs and the plurality of analog crossbars based on a traffic load.

14. The method of claim 13, further comprising predicting a traffic load using real-time metrics, historical data, or compute stack guidance.

15. The method of claim 14, further comprising adjusting power consumption of the plurality of DSPs and the plurality of analog crossbars based on the predicted traffic load.

16. The method of claim 13, further comprising powering down one or more input or output lanes of the plurality of DSPs based on the traffic load.

17. The method of claim 13, further comprising asymmetrically powering down one or more transmission or receiving lanes based on the traffic load.

18. The method of claim 13, further comprising preemptively scaling resources, including DSP lanes, crossbars, or voltage supplies for the DSP lanes or the crossbars, in response to a predicted traffic increase.

19. The method of claim 13, further comprising dynamically adjusting voltage and frequency of the plurality of DSPs and the plurality of analog crossbars using a dynamic voltage and frequency scaling (DVFS) mechanism.

20. A device, comprising:
a plurality of digital signal processors (DSPs);
a plurality of analog crossbars in communication with the plurality of DSPs; and
a switch controller operable to dynamically adjust power consumption of the plurality of DSPs and the plurality of analog crossbars based on a signal quality.
